(19) United States
(12) Patent Application Publication
(10) Pub. No.: US 2025/0299310 A1
(43) Pub. Date: Sep. 25, 2025

(54) DIGITAL IMAGE VISUAL AESTHETIC SCORE GENERATION

(71) Applicant: Adobe Inc., San Jose, CA (US)

(72) Inventors: Simon Jenni, Hagendorf (CH); Zhaowen Wang, San Jose, CA (US); John Philip Collomosse, Pyrford (GB)

(73) Assignee: Adobe Inc., San Jose, CA (US)

(21) Appl. No.: 18/611,886

(22) Filed: Mar. 21, 2024

(51) Int. Cl. G06T 7/00; G06V 10/764; G06V 20/70

(52) U.S. Cl. CPC G06T 7/0002; G06V 10/764; G06V 20/70; G06T 2207/20081; G06T 2207/20084; G06T 2207/30168

(57) ABSTRACT

Digital image visual aesthetic score generation techniques are described. In one or more examples, these techniques are implemented by a system including a training data collection module implemented by a processing device to collect training data including training digital images and user interaction data describing user interaction with the training digital images, respectively. A training module is configured to train a machine-learning model using the training data to generate an aesthetic score based on an input digital image. The aesthetic score is configured to specify an amount of visual aesthetics exhibited by the input digital image.

### BACKGROUND

Visual aesthetics are used to define “how good” a digital image looks. Accordingly, visual aesthetics are subjective and involve numerous considerations. Examples of considerations include composition, color, contrast, lighting, simplicity, unity, balance, and so forth. Further, in practice these considerations are balanced to form an overall impression of the digital image, which introduces additional complexities, e.g., in weighting how much each of the considerations contribute to an overall effect and feeling towards a digital image.

Conventional techniques as implemented by computing devices, therefore, that are tasked with quantifying visual aesthetics of a digital image encounter numerous technical challenges resulting from these subjective considerations. Additionally, conventional techniques used to quantify visual aesthetics as implemented by computing devices are expensive both computationally and fiscally in practice. These conventional techniques, in practice, often exhibit inaccuracies, generally as a result of biases introduced as part of implementing the techniques. As a result, conventional visual aesthetic computation techniques are inaccurate and often fail in real-world scenarios and therefore have an effect on other functionalities that rely on these techniques.

### SUMMARY

Digital image visual aesthetic score generation techniques are described. In one or more examples, these techniques are implemented by a system including a training data collection module implemented by a processing device to collect training data including training digital images and user interaction data describing user interaction with the training digital images, respectively. A training module is configured to train a machine-learning model using the training data to generate an aesthetic score based on an input digital image. The aesthetic score is configured to specify an amount of visual aesthetics exhibited by the input digital image.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures Entities represented in the figures are indicative of one or more entities and thus reference is made interchangeably to single or plural forms of the entities in the discussion.

FIG. 1 is an illustration of an environment in an example implementation that is operable to employ digital image visual aesthetic score generation techniques described herein.

FIG. 2 depicts a system in an example implementation showing an overview of operation of the aesthetics detection service of FIG. 1 in greater detail as employing a training module to train a machine-learning model to generate an aesthetic score.

FIG. 3 depicts a system in an example implementation showing operation of a learning signal extraction module of FIG. 2 in greater detail as part of training the machine-learning model.

FIG. 4 depicts a system in an example implementation showing operation of an aesthetics classification module of FIG. 2 in greater detail as part of training the machine-learning model.

FIG. 5 depicts a system in an example implementation showing operation of a self-training module of FIG. 2 in greater detail as part of training the machine-learning model.

FIG. 6 is a flow diagram depicting an algorithm as a step-by-step procedure in an example implementation of operations performable for accomplishing a result of machine-learning model training and use in support of digital image visual aesthetic score generation.

FIG. 7 illustrates an example system including various components of an example device that can be implemented as any type of computing device as described and/or utilize with reference to the above reference figures to implement embodiments of the techniques described herein.

### DETAILED DESCRIPTION

### Overview

Determining a visual aesthetic of a digital image, and more particularly quantifying a relative amount of visual aesthetics exhibited by the digital image, involves numerous technical challenges when implemented using a computing device. These technical challenges are typically caused by reliance on subjective considerations that act as a basis of the determination, examples of which include composition, color, contrast, lighting, simplicity, unity, balance, and so forth. Further, conventional techniques implemented using computing devices are prone to bias in an aesthetics determination, such as to weight digital images that capture landscapes and items from nature (e.g., closeups of plants) higher than digital images that capture other types of content.

Accordingly, an aesthetics detection service is employed to address these and other technical challenges by generating an aesthetic score that is usable to quantify an amount of visual aesthetics exhibited by a respective digital image using machine learning, automatically and without user intervention. To do so, the aesthetics detection service utilizes a machine-learning model that is trained and retrained using training data.

The training data includes training digital images and user interaction data. The user interaction data describes user interaction with the training digital images, e.g., a view count, number of appreciations (e.g., “likes”), number of purchases, and so forth. The user interaction data, therefore, provides insights into user opinions exhibited towards visual aesthetics depicted by the respective digital images. In this way, the techniques described herein overcome conventional technical limitations and biases in quantifying visual aesthetics of an input digital image in generating an aesthetic score to define an amount of visual aesthetic exhibited by the input digital image. The quantified visual aesthetics are usable in support of a variety of functionalities, examples of which include content recommendations, search, digital image curation, artificial intelligence (AI), and so forth.

In one or more examples, a machine-learning model is trained by an aesthetics detection service to generate an aesthetic score based on an input digital image. To do so, a training module of the aesthetics detection service utilizes a training data collection module to collect the training data. The training data, as previously described, includes training digital images and user interaction data that describes user interaction with respective training digital images. The user interaction data, for instance, is collected based on dissemination of the training digital images using one or more digital services, e.g., social media services, stock digital image services, digital image sharing services, digital content creation services, and so forth. Examples of user interactions described include view count, number of appreciations, number of purchases, number of inclusions in respective items of digital content, and so on.

The training module then trains and retrains a machine-learning model using the training data, e.g., using a loss function. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data, e.g., the training digital images and user interaction data. Examples of machine-learning models include neural networks, convolutional neural networks (CNNs), long short-term memory (LSTM) neural networks, decision trees, and so forth.

In practice, user interaction data describes interactions that are dependent on how often each digital image is presented, and as such, the user interaction data may reflect biases. To address this technical challenge as part of training the machine-learning model, in one or more examples, a learning signal extraction module is employed by the training module to address noise in the training data.

In one or more examples, the learning signal extraction module generates a learning signal as an appreciation ratio that is based on a number of appreciations divided by a number of views for respective digital images. To further reduce an amount of noise exhibited in this learning signal, the appreciation ratio is discretized into a number of buckets and aesthetics learning is implemented as a classification technique using the buckets to form respective aesthetics classification labels associated with the respective buckets.

The aesthetics classification labels are then utilized by an aesthetics classification module to generate candidate aesthetics scores and confidence estimates for those scores. The aesthetics classification module, for instance, formulates aesthetics learning as a multi-class classification task, which exhibits increased resilience towards label noise. To address incorrect labels, the confidence estimates are also generated as a confidence estimator of accuracy of the respective candidate aesthetics scores.

The candidate aesthetics scores and confidence estimates are then passed to a self-training module to reduce bias. In real-world scenarios, for instance, it has been observed that conventional techniques exhibit a bias towards nature photography, and particularly closeup photos of plants. As a result, conventional techniques exhibit a lack of diversity in digital images that are considered to have relatively high amounts of visual aesthetics.

Therefore, the self-training module is configured to promote increased diversity and accuracy in aesthetics scoring through use of a self-training technique. The self-training techniques employs confidence-filtered and cross-validated model predictions to define training signals. To do so, the candidate aesthetics scores and confidence estimates are obtained and cross-validated, e.g., “k-fold” cross validation. These training samples are then filtered, e.g., by retaining a threshold amount (e.g., top seventy-five percent) based on the respective confidence estimates.

The filtered scores are assigned to an additional set of training classes (e.g., a “new” set of buckets) to again generate aesthetics classification labels, i.e., are discretized as described above. Classifiers and confidence estimators are then trained using these revised aesthetics classification labels generated based on the above assignments to the respective buckets to arrive at a finalized trained version of the machine-learning model.

In this way, the machine-learning model is trained to exhibit reduced bias and therefore increased accuracy when compared with conventional techniques. This accuracy is operational to further improve accuracy of techniques that rely on the aesthetics scores, e.g., digital image curation, ranking, search, artificial intelligence, and so on. Further discussion of these and other examples is included in the following sections and shown in corresponding figures.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

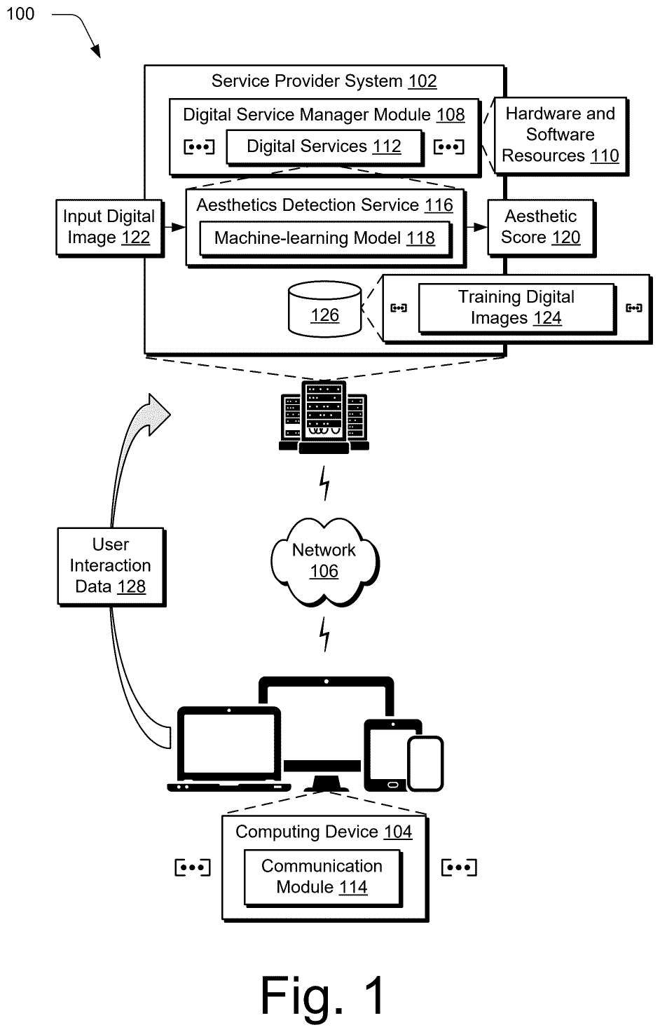

FIG. 1 is an illustration of an environment in an example implementation that is operable to employ digital image visual aesthetic score generation techniques described herein. The illustrated environment 100 includes a service provider system 102 and a computing device 104 that are communicatively coupled, one to another, via a network 106. Computing devices are configurable in a variety of ways.

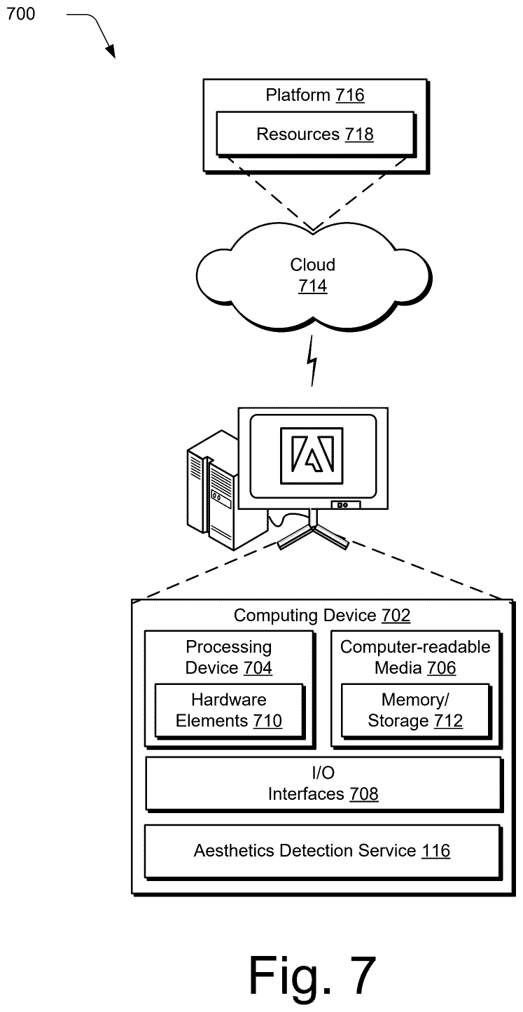

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 7.

The service provider system 102 includes a digital service manager module 108 that is implemented using hardware and software resources 110 (e.g., a processing device and computer-readable storage medium) in support one or more digital services 112. Digital services 112 are made available, remotely, via the network 106 to computing devices, e.g., computing device 104. Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

In the illustrated example, the digital services 112 are utilized to implement an aesthetics detection service 116. The aesthetics detection service 116 employs a machine-learning model 118 that is trained to generate an aesthetic score 120 that quantifies an amount of visual aesthetics expressed by an input digital image 122. The input digital image 122, for instance, as an example of previously unseen digital data is processed by the machine-learning model 118 to assign the aesthetic score 120 having high values indicating corresponding higher aesthetic qualities and vice versa. The aesthetic detection service 116 is therefore usable to support a variety of functionalities, include content recommendation, search, data curation, and so forth.

Digital services 112, for example, are configurable to curate and showcase visual content, and as a consequence, an ability to curate aesthetically pleasing digital images increases efficiency in user engagement and promotes creation of high-quality content that includes the digital images. However, curating such digital images manually through subjective human ratings is not scalable and introduces potential biases. Consequently, the aesthetics detection service 116 as a reliable automated aesthetic predictor functions to streamline content presentation and enhance user experiences.

The aesthetics detection service 116 is configured to collect a variety of training data as part of training and retraining the machine-learning model 118, illustrated examples of which include training digital images 124 which are maintained in a storage device 126 and user interaction data 128. The user interaction data 128 describes user interaction, and more particularly amounts and/or types of user interaction with respective training digital images 124.

The user interaction data 128, for instance, is obtainable from a wide variety of sources, examples of which include implementation of digital services 112 include social network services, content sharing service, stock content services, and so forth. However, the user interaction data 128, in practice, exhibits relatively high levels of noise that may hinder accuracy. To address these challenges, the aesthetics detection service 116 is configurable to employ a variety of strategies to increase accuracy of the machine-learning model 118 in generating an aesthetic score 120 based solely on an input digital image 122. The aesthetics detection service 116, for instance, is configurable to extract aesthetics labels from noisy user engagement data, train an aesthetics classifier along with confidence estimates on noisy labels, and/or perform self-training on initial confidence-filtered aesthetic scores to increase prediction diversity and coherence.

The machine-learning module 118, once trained as part of the aesthetics detection service 116, is configurable to support a variety of functionalities. The aesthetics detection service 116, for instance, is configurable as part of search functionality for filtering or re-ranking of search results. Given a user search query, the aesthetics detection service 116 is configurable to rank matches with higher predicted aesthetics, remove low-scoring matches from the search results, and so on. In this way, accurate representation of aesthetics causes increases in the perceived quality of search results and increase user engagement and satisfaction on content-sharing platforms.

In another example, accuracy in aesthetic predictions is also useful in the development of artificial intelligence models. The aesthetics detection service 116, for instance, is usable to curate training datasets for generative artificial intelligence (AI) models, guide generative models via an additional signal during training and inference, and so forth. In this way, the artificial intelligence models trained using these curated datasets are usable to accurately address visual aesthetics, which is not possible in conventional techniques. Further discussion of these and other examples is included in the following section and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Digital Image Visual Aesthetic Training

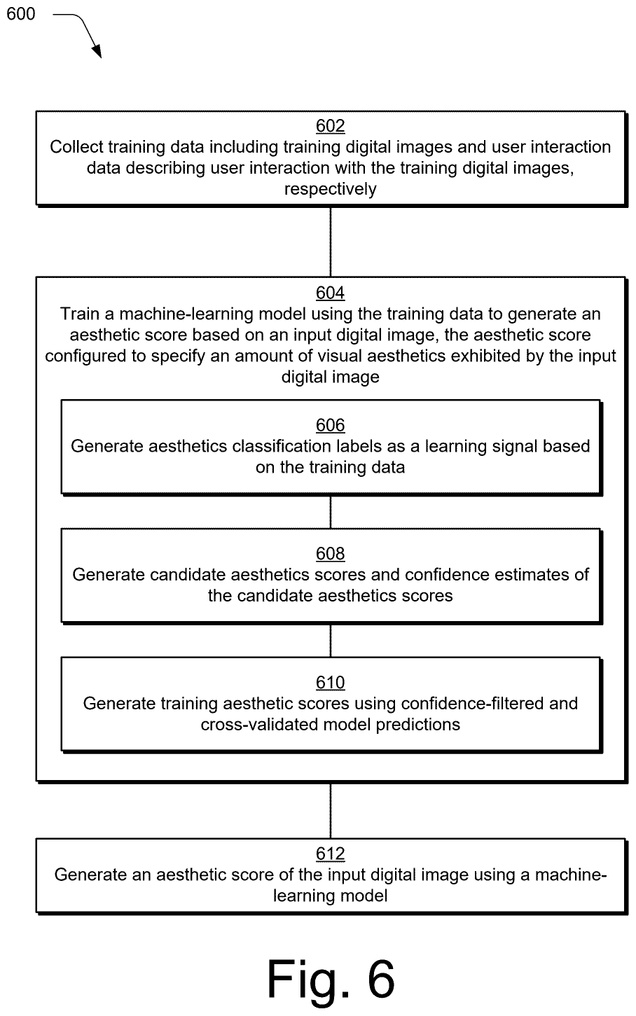

The following discussion describes digital image visual aesthetic training techniques for machine-learning models that are implementable utilizing the described systems and devices. FIG. 6 is a flow diagram depicting an algorithm 600 as a step-by-step procedure in an example implementation of operations performable for accomplishing a result of machine-learning model training and use in support of digital image visual aesthetic score generation. In portions of the following discussion, reference is made in parallel to the algorithm 600.

Aspects of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

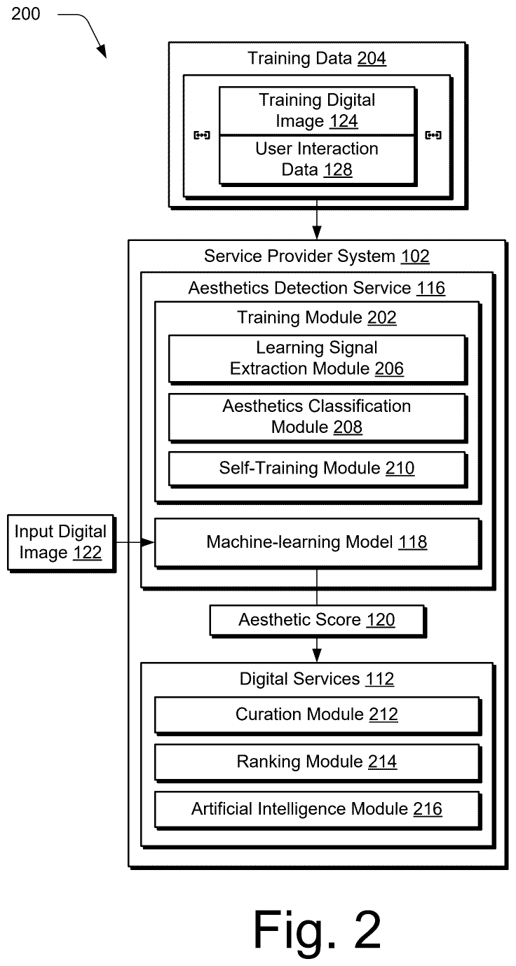

FIG. 2 depicts a system 200 in an example implementation showing an overview of operation of the aesthetics detection service 116 of FIG. 1 in greater detail as employing a training module 202 to train a machine-learning model 118 to generate an aesthetic score. The training module 202, as previously described, collects training data 204 including training digital images 124 and user interaction data 128 describing user interaction, respectively, with the digital images 124. The training module 202 then employs the training data 204 to train the machine-learning model 118 to generate an aesthetic score 120 as previously described.

The training module 202 employs an approach to train a machine-learning model 118 to assign an aesthetic score 120 to a previously unseen input digital image 122. To do so, the machine-learning model 118 learns a function “F” (e.g., parametrized by a neural network) mapping images “xᵢ” to a scalar score “F(x)∈[0,1],” where higher values in this instance indicate higher aesthetics. To train the machine-learning model 118, training data 204 is collected including a set of training digital images 124 “X={x₁, . . . , x_{N}}” along with corresponding user interaction data 128, e.g., user engagement statistics such as view count, a number of appreciations (e.g., “likes”), and so forth.

Because the training data 204 is dependent on how the training digital images 124 are provided to respective consumers, and thus influence subsequent user interactions described by the user interaction data 128, the training module 202 is configured to employ a variety of functionalities to denoise and improve accuracy in training of the machine-learning model 118. Examples of these functionalities include a learning signal extraction module 206, an aesthetics classification module 208, and a self-training module 210.

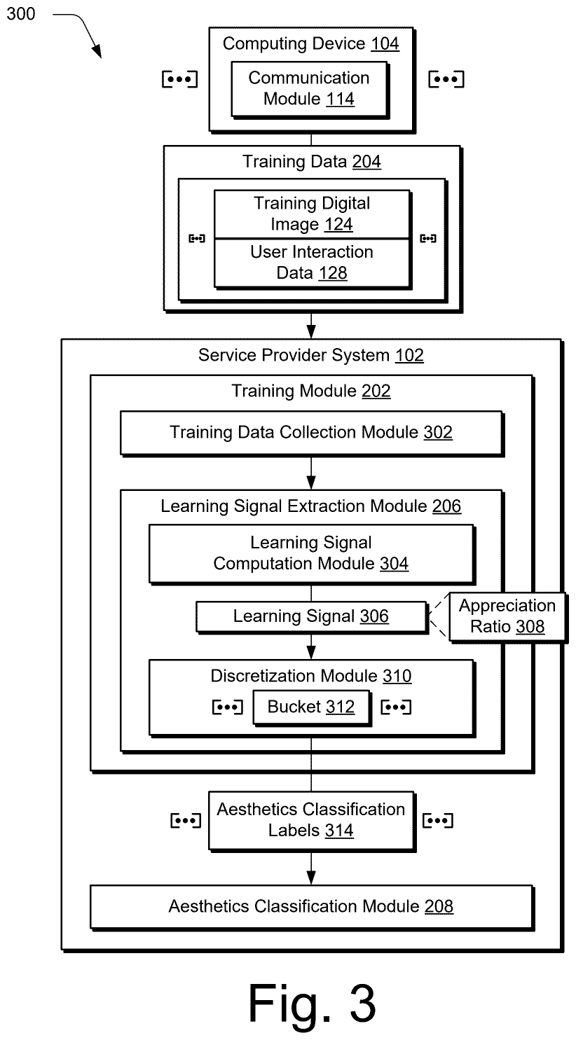

The learning signal extraction module 206 is configured to address an effect of how many times a respective training digital image 124 is exposed to potential consumers. The learning signal extraction module 206 is also configured to pose aesthetics learning as a classification technique through discretization using a plurality of buckets, further discussion of which may be found in relation to FIG. 3.

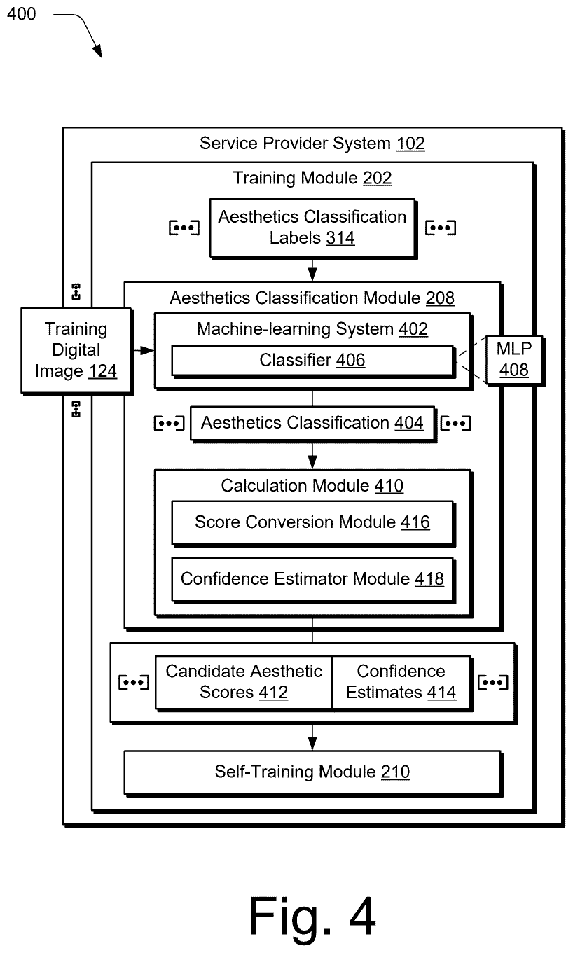

The aesthetics classification module 208 is configured to address noise and potential incorrect labeling in an output of the learning signal extraction module 206. To do so in one or more examples, the aesthetics classification module 208 generates candidate aesthetic scores with corresponding confidence estimates, further discussion of which may be found in relation to FIG. 4.

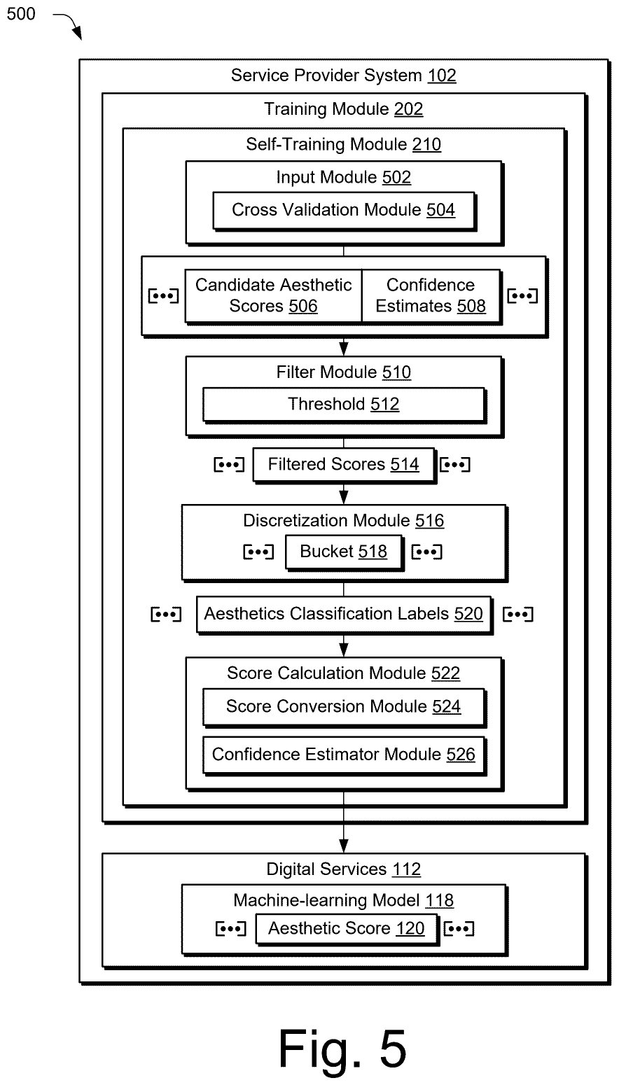

The self-training module 210 is configured to receive the candidate aesthetic scores with corresponding confidence estimates from the aesthetics classification module 208 to then train the machine-learning model 118 as part of a self-training technique. In one or more examples, the self-training module 210 cross validates the candidate aesthetic scores output by the aesthetics classification module 208 and filters the scores based on the confidence estimates. The remaining training samples are then used as a basis to repeat the discretization, generation of candidate aesthetics scores and confidence estimates to train the machine-learning model 118. Further discussion of operation of the self-training module 210 may be found in relation to FIG. 5.

The machine-learning model 118, once trained, is configured to support a variety of digital services 112 through processing of an input digital image 122 to generate an aesthetic score 120. Illustrated examples are represented as a curation module 212 configured to employ the aesthetic score 120 as part of digital image curation, a ranking module 214 configured to rank digital images based on aesthetic scores (e.g., as part of a search result), an artificial intelligence module 216 to employ aesthetic scores 120 as part of training of machine-learning models, and so forth.

FIG. 3 depicts a system 300 in an example implementation showing operation of the learning signal extraction module 206 in greater detail as part of training the machine-learning model 118. The training module 202 employs a training data collection module 302 in this example to collect training data 304. The training data 204 includes training digital images 124 and user interaction data 128 describing user interaction with the training digital images, respectively (block 602). The user interaction data 128, for instance, is collected from computing devices 104 based on dissemination of the training digital images 124 to those devices using one or more digital services 112, e.g., social media services, stock digital image services, digital image sharing services, digital content creation services, and so forth. Examples of user interactions described include view count, number of appreciations, number of purchases, number of inclusions in respective items of digital content, and so on.

The training data 204 is then used to train a machine-learning model 118 to generates the aesthetic score 120 based on an input digital image 122, e.g., a previously unseen digital image. The aesthetic score is configured to specify an amount of visual aesthetics exhibited by the input digital image (block 604). To begin in this example, the learning signal extraction module 206 generates aesthetics classification labels as a learning signal based on the training data 204 (block 606).

As previously described, the machine-learning model 118 is trained using training data 204 having training digital images 124 and user interaction data 128. The user interaction data 128, for instance, includes counts for the number of views and appreciations (or likes) for each respective training digital images 124. However, because both of these numbers are dependent on how often each training digital image 124 is presented, these numbers may lack accuracy as an indicator of quality, reflect biases in digital services 112 used to disseminate the training digital images 124 (e.g., as recommendations), and so forth.

Accordingly, in this example the training data 304 is configured to generate a learning signal 306 as an appreciation ratio. An appreciation ratio for a training digital image 124 “xᵢ”, for instance, is expressed as:

$${α}_{i} = {\#appreciations}_{i} / {\#views}_{i}$$

Due to a considerable amount of underlying noise in this learning signal 306, however, a straightforward regression of this ratio introduces additional technical complications.

Accordingly, a discretization module 310 is employed in the illustrated example to discretize the appreciation ratio 308 into “K” equal-sized buckets 312. Aesthetics learning is then posed as a classification of these buckets 312, instead, to form corresponding aesthetics classification labels 314 from the respective buckets 312. Aesthetics classification labels are definable as:

$${y}_{i} = j if {α}_{i} ∈ [ {p}_{j - 1} , {p}_{j} ] ,$$

where “pⱼ” is the “j/K” percentile of the “ai” values in the training data 204 and “j ∈{1, . . . , K}.” The corresponding aesthetics classification labels 314 (based on correspondence to buckets 312 defining respective amounts of visual aesthetics for respective training digital images 124) are then passed as an input to the aesthetics classification module 208 for further processing.

FIG. 4 depicts a system 400 in an example implementation showing operation of the aesthetics classification module 208 in greater detail as part of training the machine-learning model 118. The aesthetics classification module 208 is configured to learn an aesthetic classification from the training digital images 124. The aesthetics classification module 208 in this example employs a machine-learning system 402 configured to generate aesthetics classifications 404 using a classifier 406.

The classifier 406, for instance, is configurable using a pre-trained visual encoder “E” based on a visual transformer (ViT) architecture, which is trained to associate digital images and captions using image-text contrastive learning (CLIP). Other image encoders are also contemplated. The classifier 406, therefore, is configured to capture various latent visual features that are indicative of user-perceived aesthetics, e.g., about style, content, and/or composition of the digital image. In an implementation, latent features “fᵢ=E(xᵢ)” remain fixed and an aesthetics classifier “σ(fᵢ)∈R^{K}” is learned. The classifier 406 “σ” is implemented as a three-layer multilayer perceptron (e.g., illustrated as MLP 408) with a softmax output activation and trained via a cross-entropy loss:

$$ℓ i = - log σ ( {f}_{i} ) {y}_{i}$$

where the subscript selects the ground-truth aesthetics class output “yᵢ.”

Candidate aesthetics scores and confidence estimates of the candidate aesthetics scores are then generated (block 608) based on the aesthetics classifications 404. The confidence estimate is usable at inference time, e.g., in reranking or filtering of search results. For example, digital images with low aesthetics scores may be filtered if these images also sow a high model confidence, e.g., similar with high scores and confidence for up-ranking results. At inference, for instance, output of the machine-learning system 402 (e.g., the aesthetics classification 404) is passed to a calculation module 410 to calculate candidate aesthetic scores 412 and confidence estimates 414. A score conversion module 416 is utilized to convert the classifier 406 outputs to a real-valued score (i.e., the candidate aesthetic scores 412) via:

$${s}_{i} = \frac{1}{K} {\sum }_{k = 1}^{K} ( k - 1 ) {σ ( {f}_{i} )}_{{y}_{i}}$$

Formulating aesthetics detection as a multi-class classification task improves a machine-learning process from noisy data based on resilience in real-world scenarios to label noise. However, incorrect labels still diminish training accuracy and can also result in overconfident false predictions at inference. To address these technical challenges, a confidence estimator module 418 is employed to generate confidence estimates 414, e.g., to learn a confidence estimator “γ,” which is implemented as a separate MLP regression head on top of the latent features “fᵢ” described above. As the confidence learning signal, classification loss error is used, i.e., to train “γ” on the following loss:

$${‖ γ ( {f}_{i} ) - {ℓ}_{i} ‖}_{2}^{2}$$

where the output of “γ” contains a soft-plus activation. For testing, a value of:

$${\hat{γ}}_{i} = max ( \frac{{ℓ}_{*} - γ ( {f}_{i} )}{{ℓ}_{*}} , 0 ) ∈ [ 0 , 1 ]$$

is used where “ [symbol] *” is a largest classification error observed from the training dataset. The candidate aesthetic scores 412 and the confidence estimates 414 are then passed form the aesthetics classification module 208 to the self-training module 210 to complete training of the machine-learning model 118 as further described below.

FIG. 5 depicts a system 500 in an example implementation showing operation of the self-training module 210 in greater detail as part of training the machine-learning model 118. As previously described, another issue caused by noise in the training data 204 involves bias. In practice, for instance, it has been observed that conventional techniques result in a clear bias towards nature photography, particularly close-up photos of plants as opposed to other types of digital images. These biases can result in a lack of diversity among the top-scoring images, limiting the machine-learning model's usefulness in applications like search re-ranking.

To address these technical challenges and achieve increased diversity and accuracy in generating the aesthetic score 120, the training module 202 implements the self-training module 210 as representative of a self-training scheme using confidence-filtered cross-validated model predictions to define training signals. An input module 502, for instance, utilizes a cross validation module 504 to output candidate aesthetic scores 506 and confidence estimates 508 for the training digital images that are generated using cross-validation. In other words, the cross validation module 504 cross validates the candidate aesthetic scores 412 and confidence estimates 414, e.g., for training and validating using respective segments of the data.

A filter module 510 is then employed that utilizes a threshold 512 to generate filtered scores 514 from the output candidate aesthetic scores 506 based on the confidence estimates 508. The filter module 510, for instance, is configured to employ the threshold 512 to retain a defined amount (e.g., top seventy five percent) of the output candidate aesthetic scores 506 based on the confidence estimates 508. The filtered scores 514 are then passed as an input to a discretization module 516.

The discretization module 516, like the discretization module 310 of FIG. 3, is configured to assign aesthetics classification labels 520 by discretizing the filtered scores 514 into a plurality of classes associated, respectively, with a plurality of buckets 518. Newly initialized classifiers and confidence estimators of a score calculation module 522 (e.g., represented using a score conversion module 524 and a confidence estimator module 526) are then trained on these revised aesthetics classification labels 520 (block 610) to complete, at least initially, training of the machine-learning model 118. The machine-learning model 118, once trained is configured to generate an aesthetic score 120 of the input digital image 122 (block 612), e.g., as part of digital services 112 as previously described. In this way, the aesthetics detection service 116 is configured to address a variety of technical challenges by generating an aesthetic score that is usable to quantify an amount of visual aesthetics exhibited by a respective digital image using machine learning, automatically and without user intervention.

### Example System and Device

FIG. 7 illustrates an example system generally at 700 that includes an example computing device 702 that is representative of one or more computing systems and/or devices that implement the various techniques described herein. This is illustrated through inclusion of the aesthetics detection service 116. The computing device 702 is configurable, for example, as a server of a service provider, a device associated with a client (e.g., a client device), an on-chip system, and/or any other suitable computing device or computing system.

The example computing device 702 as illustrated includes a processing device 704, one or more computer-readable media 706, and one or more I/O interface 708 that are communicatively coupled, one to another. Although not shown, the computing device 702 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 704 is representative of functionality to perform one or more operations using hardware. Accordingly, the processing device 704 is illustrated as including hardware element 710 that is configurable as processors, functional blocks, and so forth. This includes implementation in hardware as an application specific integrated circuit or other logic device formed using one or more semiconductors. The hardware elements 710 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 706 is illustrated as including memory/storage 712 that stores instructions that are executable to cause the processing device 704 to perform operations. The memory/storage 712 represents memory/storage capacity associated with one or more computer-readable media. The memory/storage 712 includes volatile media (such as random access memory (RAM)) and/or nonvolatile media (such as read only memory (ROM), Flash memory, optical disks, magnetic disks, and so forth). The memory/storage 712 includes fixed media (e.g., RAM, ROM, a fixed hard drive, and so on) as well as removable media (e.g., Flash memory, a removable hard drive, an optical disc, and so forth). The computer-readable media 706 is configurable in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing. device 702. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 702, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 710. The computing device 702 is configured to implement particular instructions and/or functions corresponding to the software and/or hardware modules. Accordingly, implementation of a module that is executable by the computing device 702 as software is achieved at least partially in hardware, e.g., through use of computer-readable storage media and/or hardware elements 710 of the processing device 704. The instructions and/or functions are executable/operable by one or more articles of manufacture (for example, one or more computing devices 702 and/or processing devices 704) to implement techniques, modules, and examples described herein.

The techniques described herein are supported by various configurations of the computing device 702 and are not limited to the specific examples of the techniques described herein. This functionality is also implementable all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 include. applications and/or data that can be utilized while computer processing is executed on servers that are remote from the computing device 702. Resources 718 can also include services provided over the Internet and/or through a subscriber network, such as a cellular or Wi-Fi network.

The platform 716 abstracts resources and functions to connect the computing device 702 with other computing devices. The platform 716 also serves to abstract scaling of resources to provide a corresponding level of scale to encountered demand for the resources 718 that are implemented via the platform 716. Accordingly, in an interconnected device embodiment, implementation of functionality described herein is distributable throughout the system 700. For example, the functionality is implementable in part on the computing device 702 as well as via the platform 716 that abstracts the functionality of the cloud 714.

In implementations, the platform 716 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, an input digital image;
generating, by the processing device, an aesthetic score of the input digital image using a machine-learning model, the machine-learning model trained using training digital images and user interaction data describing user interaction with the training digital images, respectively; and
outputting, by the processing device, the aesthetic score.

2. The method of claim 1, wherein the aesthetic score is configured to specify an amount of visual aesthetics exhibited by the input digital image.

3. The method as described in claim 1, wherein the user interaction data describes, respectively, a number of appreciations of the training digital images and a number of views of the training digital images.

4. The method as described in claim 1, further comprising training the machine-learning model using training data including the training digital images and the user interaction data describing user interaction with the training digital images, respectively.

5. The method as described in claim 4, wherein the training includes generating aesthetics classification labels as a learning signal based on the training data.

6. The method as described in claim 5, wherein the generating aesthetics classification labels includes:
generating a learning signal based on the training data; and
generating the aesthetics classification labels through aesthetics learning as a classification of the learning signal into respective buckets.

7. The method as described in claim 4, wherein the training includes generating candidate aesthetics scores and confidence estimates of the candidate aesthetics scores.

8. The method as described in claim 7, wherein the generating the candidate aesthetics scores and the confidence estimates of the candidate aesthetics scores includes:
generating aesthetics classifications using a classifier; and
generating the candidate aesthetics scores and the confidence estimates based on the aesthetics classifications.

9. The method as described in claim 4, wherein the training includes generating training aesthetic scores using confidence-filtered and cross-validated model predictions by:
outputting candidate aesthetic scores and confidence estimates for the training images that are generated using cross-validation;
generating filtered scores by filtering the candidate aesthetic scores based on the confidence estimates;
assigning aesthetics classification labels by discretizing the filtered scores into a plurality of classes associated, respectively, with a plurality of buckets; and
training the machine-learning model based on aesthetic scores and confidence estimates generated based on the aesthetics classification labels.

10. A system comprising:
a training data collection module implemented by a processing device to collect training data including training digital images and user interaction data describing user interaction with the training digital images, respectively; and
a training module configured to train a machine-learning model using the training data to generate an aesthetic score based on an input digital image, the aesthetic score configured to specify an amount of visual aesthetics exhibited by the input digital image.

11. The system as described in claim 10, wherein the training module includes a learning signal extraction module that is configured to generate aesthetics classification labels as a learning signal based on the training data.

12. The system as described in claim 11, wherein the learning signal extraction module includes:
a learning signal computation module configured to generate a learning signal based on the training data; and
a discretization module configured to generate the aesthetics classification labels through aesthetics learning as a classification of the learning signal into respective buckets.

13. The system as described in claim 12, wherein the learning signal is based on a number of appreciations of the training digital images and a number of views of the training digital images.

14. The system as described in claim 10, wherein the training module includes an aesthetic classification module that is configured to generate candidate aesthetics scores and confidence estimates of the candidate aesthetics scores.

15. The system as described in claim 14, wherein the aesthetic classification module includes:
a machine-learning system configured to generate aesthetics classifications using a classifier; and
a calculation module configured to generate the candidate aesthetics scores and the confidence estimates based on the aesthetics classifications.

16. The system as described in claim 15, wherein the machine-learning system is configured to generate the aesthetics classifications based on aesthetics classification labels generated through aesthetics learning as a classification of a learning signal into respective buckets based on the training data.

17. The system as described in claim 10, wherein the training module includes a self-training module that is configured to generate training aesthetic scores using confidence-filtered and cross-validated model predictions.

18. The system as described in claim 17, wherein the self-training module includes:
a cross-validation module configured to output candidate aesthetic scores and confidence estimates for the training images that are generated using cross-validation;
a filter module configured to generate filtered scores by filtering the candidate aesthetic scores based on the confidence estimates;
a discretization module configured to assign aesthetics classification labels by discretizing the filtered scores into a plurality of classes associated, respectively, with a plurality of buckets; and
a score calculation module configured to train the machine-learning model based on training aesthetic scores and confidence estimates generated based on the aesthetics classification labels.

19. The system as described in claim 10, wherein the user interaction data describes relative amounts of user interaction with the training digital images, respectively.

20. A method comprising:
collecting, by a processing device, training data including training digital images and user interaction data describing user interaction with the training digital images, respectively; and
training, by the processing device, a machine-learning model using the training data to generate an aesthetic score based on an input digital image, the aesthetic score configured to specify an amount of visual aesthetics exhibited by the input digital image.
